(19) United States
(12) Patent Application Publication
(10) Pub. No.: US 2018/0066080 A1
(43) Pub. Date: Mar. 8, 2018

(54) APPARATUS AND METHOD FOR PRODUCING THERMOPLASTIC ELASTOMER, ELASTOMERS PRODUCED THEREBY AND ARTICLES PRODUCED FROM THE ELASTOMERS

(71) Applicant: Neal A. Evans, Traverse City, MI (US)

(72) Inventor: Neal A. Evans, Traverse City, MI (US)

(21) Appl. No.: 15/810,772

(22) Filed: Nov. 13, 2017

Related U.S. Application Data
(63) Continuation of application No. 14/134,593, filed on Dec. 19, 2013.
Application No. 14/134,593 is a continuation of application No. 13/861,725, filed on Apr. 12, 2013, now abandoned.
Application No. 13/861,725 is a continuation of application No. 12/892,286, filed on Sep. 28, 2010, now abandoned.

(51) Int. Cl. C08F 8/02; B29C 47/60; C08J 3/00; B29B 7/42; C08L 19/00; C08L 101/00

(52) U.S. Cl. CPC C08F 8/02; B29C 47/6087; B29C 47/6056; C08J 3/005; C08L 101/00; C08L 19/003; C08J 2321/00; C08J 2300/22; B29B 7/42

(57) ABSTRACT

A method for producing thermoplastic elastomer is disclosed and comprises the step of: blending a mixture including particles of vulcanized rubber material and a molten thermoplastic material such that the rubber material is subjected to mechanical shearing forces and the surfaces of the rubber particles undergo homolytic bond scission to form chains of free radicals which cross-link with the thermoplastic material. Apparatus for carrying out the method, elastomers produced by the method and articles produced from the elastomers are also disclosed.

### CROSS-REFERENCE TO RELATED APPLICATIONS

This application is a continuation of U.S. patent application Ser. No. 14/134,593 filed on Dec. 19, 2013, which is a continuation of Ser. No. 13/861,725 filed on Apr. 12, 2013, now abandoned, which is a continuation of U.S. patent application Ser. No. 12/892,286 filed on Sep. 28, 2010, now abandoned.

### FIELD OF THE INVENTION

The invention relates to the field of tire and plastic recycling.

### BACKGROUND OF THE INVENTION

The proper management of scrap tire rubber and scrap plastic is a worldwide concern. Although numerous attempts have been made to recycle tire rubber by incorporation into recycled thermoplastics, previous attempts have not met with substantial commercial success. Without intending to be bound by theory, known prior attempts involved the use of additives to improve mechanical properties of the blend and, despite extensive experimentation regarding the amount and type of additive to be used, prior marketplace entrants failed to produce a product that could be sold at profit, having regard to the cost of alternatives with similar physical properties and consumer appeal.

### SUMMARY OF THE INVENTION

A method for producing thermoplastic elastomer forms one aspect of the invention and comprises the step of: blending a mixture including particles of vulcanized rubber material and a molten thermoplastic material such that the rubber material is subjected to mechanical shearing forces and the surfaces of the rubber particles undergo homolytic bond scission to form chains of free radicals which cross-link with the thermoplastic material.

According to another aspect of the invention, the ratio, by weight, of rubber material to thermoplastic material in the mixture can range between about 1:9 and about 4:1.

According to another aspect of the invention, the rubber material can be cryogenically ground scrap tire rubber.

According to another aspect of the invention, the thermoplastic material can be one of PP, HDPE, LDPE, ABS, PET and PVC.

According to another aspect of the invention, the thermoplastic material can be one of PP, LDPE and HDPE.

According to another aspect of the invention, the thermoplastic material can be recycled post-industrial thermoplastic material.

According to another aspect of the invention, the rubber material can have a size between 10 mesh and 100 mesh.

According to another aspect of the invention, the rubber material can have a size between 10 mesh and 60 mesh.

According to another aspect of the invention, the rubber material can have a size between 10 mesh and 40 mesh.

According to another aspect of the invention, the mixture can consist of the rubber material and the thermoplastic material.

According to another aspect of the invention, the mixture can consist essentially of the rubber material and the thermoplastic material.

According to another aspect of the invention, blending can be carried out in an extruder.

According to another aspect of the invention, the extruder can operate at a compounding temperature between about 375 F and about 450 F.

According to another aspect of the invention, the extruder can be a twin-screw extruder operating at a screw speed between about 400 rpm and about 650 rpm.

According to another aspect of the invention, the L/D ratio of the extruder can be about 36:1.

According to another aspect of the invention, the blending step can comprise the following substeps: feeding a particulate thermoplastic material to the extruder to produce, interiorly of the extruder, the molten thermoplastic material; and feeding the particles of rubber material into the extruder and to the molten thermoplastic material to produce the mixture.

According to another aspect of the invention, the mixture can be subjected to said mechanical shearing forces by passage through kneading blocks.

Forming other aspects of the invention are elastomers produced by the method and articles molded from the elastomers.

Forming yet another aspect of the invention is a thermoplastic elastomer comprising: a continuous phase of thermoplastic; and rubber particles dispersed in the thermoplastic phase, the rubber particles having a vulcanized core and a non-vulcanized surface layer cross-linked with the thermoplastic phase.

According to another aspect of the invention, the thermoplastic is one of PP, HDPE and LDPE and the elastomer consists essentially of the rubber particles and the thermoplastic phase.

Apparatus for use with particles of vulcanized rubber material and a thermoplastic material, the apparatus comprising: an extruder adapted to, in use, blend a mixture including said particles of vulcanized rubber material and said thermoplastic material in molten form, such that said rubber material is subjected to mechanical shearing forces and the surfaces of the rubber particles undergo homolytic bond scission to form chains of free radicals which cross-link with said thermoplastic material.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter being briefly described hereinafter.

### BRIEF DESCRIPTION OF THE DRAWINGS

FIG. 1A is a side view of a type 8058-XX.21-080/080 extruder screw thread segment;

FIG. 1B is a side view of a type 8058-XX.21-060/060 extruder screw thread segment;

FIG. 1C is a side view of a type 8058-XX.21-040/040 extruder screw thread segment;

FIG. 1D is a side view of a type 8058-XX.21-030/030 extruder screw thread segment;

FIG. 1E is a side view of a type 8058-XX.26-405/030 extruder screw thread segment;

FIG. 1F is a side view of a type 8058-XX.26-405/040 extruder screw thread segment;

FIG. 1G is a side view of a type 8058-XX.26-405/060 extruder screw thread segment;

FIG. 1H is a side view of a type 8058-XX.26-405/080 extruder screw thread segment;

FIG. 1I is a side view of a type 8058-XX.26-905/060 extruder screw thread segment;

FIG. 1J is a side view of a type 8058-XX.51-060/030-LH extruder screw thread segment; and

FIG. 2 is a side schematic view of a screw and extruder body according to another embodiment.

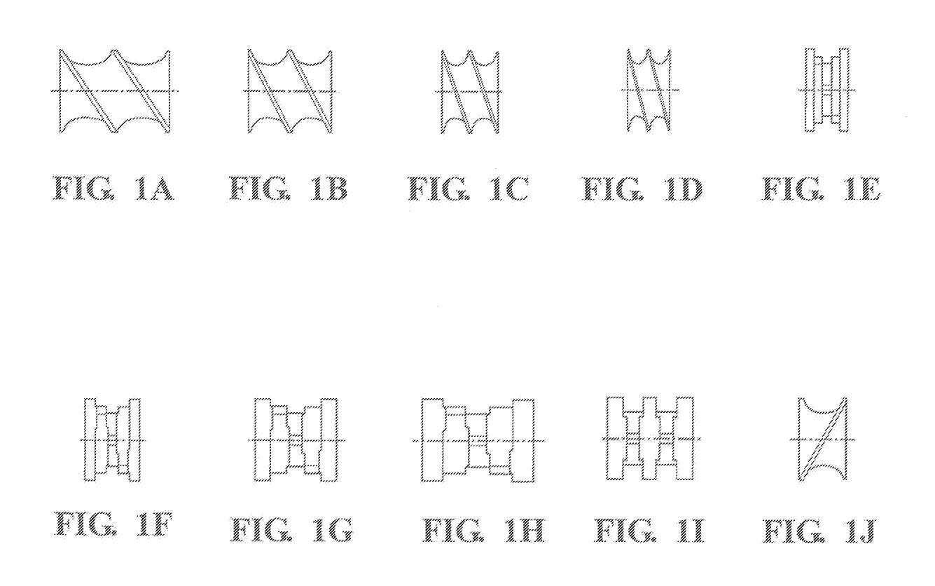

### DETAILED DESCRIPTION OF THE PREFERRED EMBODIMENTS

As an initial matter, and with reference to paragraphs [0024]-[0034], it will be understood that the numeric in the form “XXX/XXX” indicates screw pitch/length.

An exemplary embodiment of the method for producing thermoplastic elastomer of the present invention involves the use of: (i) a multi-barrel, twin-screw, vented, co-rotating, closely-intermeshing, high speed, high torque and horsepower extruder having an L/D ratio about 36:1, operating at a screw speed between about 400 rpm and about 650 rpm and a temperature between about 375 F and about 450 F; and (ii) a screw constructed according to the teachings of the present invention.

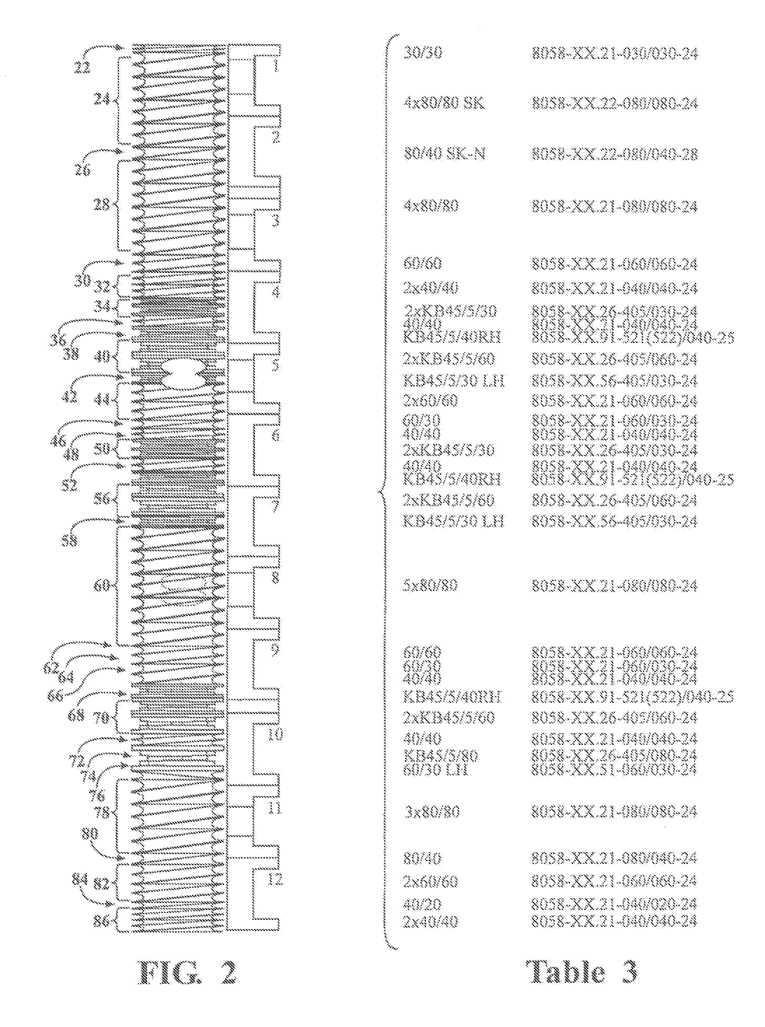

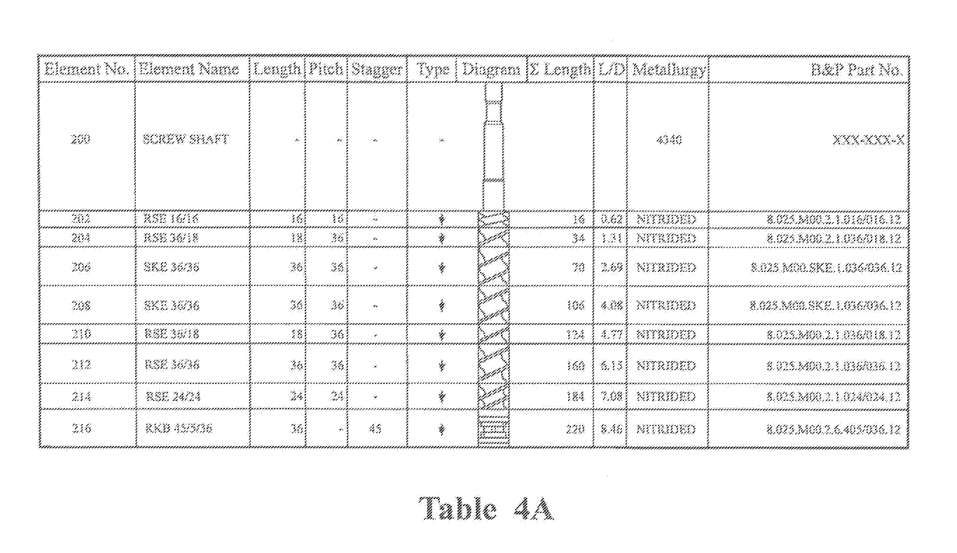

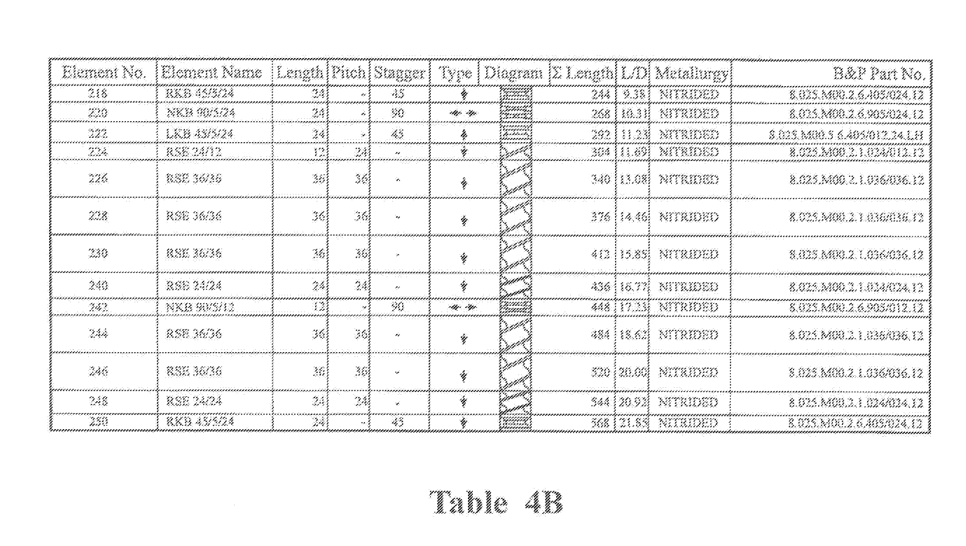

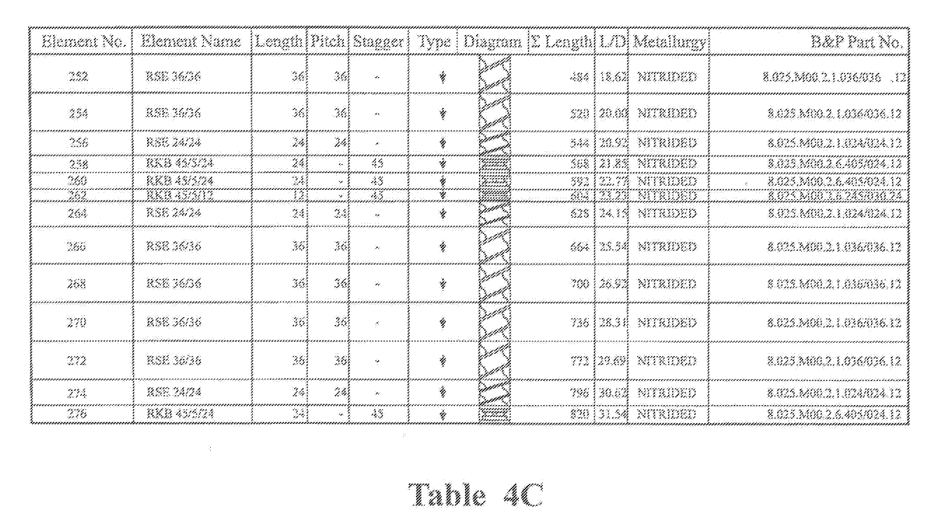

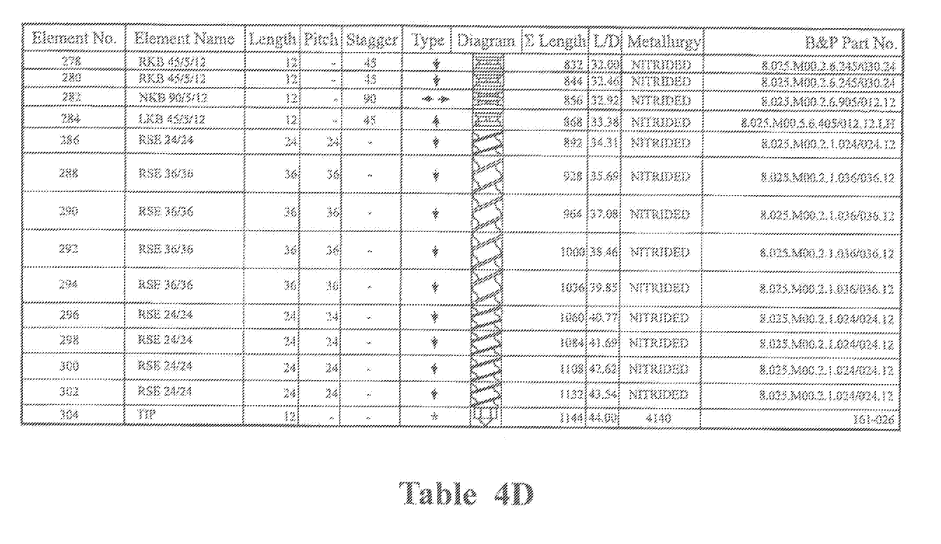

A screw for a 58 mm diameter extruder according to the teachings of the present invention can be constructed using combinations of the screw segments shown in FIGS. 2A through 2J arranged as per Table 1. For greater certainty, it should be understood that, in the table below, various zones and associated screw configurations are mentioned, and that, according to the present invention, screw segments operatively assembled in the order set forth below produce a screw suitable for use, in pairs, in the present invention.

TABLE 1

| ZONE | SCREW CONFIGURATION |
|---|---|
| Feed | FIG. 2A |
| Conveying and compression | FIG. 2B, 2C |
| Melting | FIG. 2E, 2F, 2G, 2J |
| Conveying (1) | FIG. 2B, 2A |
| Downstream Addition | FIG. 2A |
| Conveying (2) | FIG. 2B, 2C, 2D |
| Mixing (1) | FIG. 2E, 2F, 2G |
| Conveying (3) | FIG. 2B, 2C, 2D |
| Mixing (1) | FIG. 2G, 2H, 2I |
| Devolatization | FIG. 2A |
| Conveying (4) | FIG. 2B, 2C |
| Pumping | FIG. 2D |

Turning now to the method, same will be described with reference to the zones indicated above:

### Feed Zone

In the feed zone, which is characterized by a wide pitch screw, thermoplastic material is introduced to the twin screw extruder in any conventional manner. The thermoplastic material can be one of comminuted, recycled, post-industrial PP, HDPE and LDPE. The feed zone can be defined, for example, by the first barrel of a nine barrel extruder.

### Conveying and Compression Zone

In this zone, characterized by a gradually decreasing screw pitch, thermoplastic material is moved away from the feed throat and compressed to begin a melting process. This zone can be defined, for example, by the second barrel of a nine barrel extruder.

### Melting

In this zone, which is characterized by kneading blocks and a reverse pitch screw, shear is introduced, to complete the melting process and produce a molten thermoplastic material. This zone can be defined, for example, by the third barrel of a nine barrel extruder.

### Conveying (1)

In this zone, which is characterized by a medium-wide pitch, material is conveyed out of the Melting zone.

### Downstream Addition

In this zone, which is characterized by a wide pitch screw, crumb rubber is incorporated into molten thermoplastic via a side feeder. The rubber must be steel and fibre free and is introduced in any controlled, conventional manner, in a ratio, by weight, of rubber material to thermoplastic material ranging between about 1:9 and about 4:1. The rubber material can be 10 mesh or finer. Colorant, fire retardant and other conventional additives may also be added here. There is no need for additives for promoting cross-linking; accordingly, the mixture can be fairly described as consisting essentially of rubber and thermoplastic. This zone can be defined, for example, by the 4^{th} barrel of a nine-barrel extruder.

### Conveying (2)

In this zone, which is characterized by a gradually decreasing screw pitch, the partially mixed materials are moved away from the side feeder.

### Mixing (1)

In this zone, which is characterized by kneading blocks, the rubber is distributed throughout the thermoplastic. This zone can be defined, for example, by the fifth barrel of a nine barrel extruder.

### Conveying (3)

In this zone, which is characterized by a gradually decreasing screw pitch, the mixture is conveyed towards zone Mixing (2).

### Mixing (2)

In this zone, which is characterized by kneading blocks, the mixture is subjected to high shear such that the rubber material is subjected to mechanical shearing forces and the surfaces of the rubber particles undergo homolytic bond scission to form chains of free radicals which cross-link with the thermoplastic material. Again, it is emphasized that no catalysts or other active agents are provided to effect this cross-linking. This zone can be defined, for example, by the sixth barrel of a nine barrel extruder.

### Devolatization

In this zone, which is characterized by a wide screw pitch, volatiles and moisture are permitted to vent. This zone can be defined, for example, by the seventh barrel of a nine barrel extruder.

### Conveying (3)

In this zone, which is characterized by a gradually decreasing pitch, the blend is moved away from the vent and pressure is built. This zone can be defined, for example, by the eight barrel of a nine barrel extruder.

### Pumping

In this zone, which is characterized by a narrow screw pitch, pressure is built for discharge of the molten thermoplastic elastomer from the extruder. This zone can be defined, for example, by the ninth barrel of a nine barrel extruder.

### Post Extrusion Handling

Once discharged from the extruder, the mixture can be handled in any conventional manner but will typically be pelletized in a conventional manner for subsequent molding use. Useful pellet sizes, for example, can range between 0.125 and 0.1875 inches.

### Elastomer

The elastomer end product is characterized by a continuous phase of thermoplastic and rubber particles dispersed in the thermoplastic phase. The rubber particles have a vulcanized core and a non-vulcanized surface layer cross-linked with the thermoplastic phase.

These elastomer pellets can be used like other commodity thermoplastic elastomer pellets.

In terms of utility for molding, the pellets have been found to be quite advantageous, as molded articles made using these pellets can solidify faster and more evenly than articles made using virgin resins. Without intending to be bound by theory, it is believed that, when heated during molding, the temperature of the thermoplastic phase rises faster than the temperature of the vulcanized rubber such that, in the mold, a temperature gradient exists between the vulcanized particles and the thermoplastic phase. When the molten matrix enters the cooling cycle, the different temperatures of the thermoplastic phase and the rubber equilibrate, with the result that the thermoplastic solidifies faster than does virgin resin. This has advantages in terms of cycle time.

In terms of the physical properties obtainable through the process, the method of the present invention was used to produce six thermoplastic elastomers which were tested for melt flow index, density, tensile properties, flexural modulus, hardness, notched Izod and heat deflect temperature, using ASTM methods D1238, D792, D638, D790, D2240, D256 and D648. The results, as set forth in Table 2 below, show that these elastomer products all have physical properties that render them suitable as low-cost commodity thermoplastic elastomers.

TABLE 2

| | Mixture | | | | | | | | | | | |
|---|---|---|---|---|---|---|---|---|---|---|---|---|
| | 20% rubber | | 25% rubber | | 30% rubber | | 20% rubber | | 25% rubber | | 30% rubber | |
| Physical Properties | 80% PP | | 75% PP | | 70% PP | | 80% HDPE | | 75% HDPE | | 70% HDPE | |
| Melt flow rate g/10 min@230° | 11.38 | | 13.41 | | 12.81 | | 7.82 | | 6.73 | | 5.96 | |
| C./2.16 kg ASTM D1238 | | | | | | | | | | | | |
| Density, gram/cc | 0.957 | | .969 | | .966 | | .946 | | .965 | | .966 | |
| ASTMD792 | | | | | | | | | | | | |
| Tensile: yield stress, psi | 2542 | (8) | 2237 | (14) | 2028 | (13) | 1832 | (7) | 1684 | (6) | 1684 | (6) |
| ASTM D638 | | | | | | | | | | | | |
| Tensile: yield strain, % | 8.4 | (0.6) | 8.2 | (0.8) | 9.5 | (0.3) | 15.6 | (0.9) | 17.2 | (1.2) | 17.4 | (0.8) |
| ASTM D638 | | | | | | | | | | | | |
| Tensile: Modulus, kpsi | 110.6 | (1.2) | 99.9 | (2.4) | 86.2 | (1.4) | 53.7 | (1.0) | 46.3 | (1.9) | 42.7 | (1.7) |
| ASTM D638 | | | | | | | | | | | | |
| Tensile: Ultimate Strain, % | 14.7 | (2.7) | 11.0 | (2.9) | 13.4 | (1.1) | 31.1 | (9.5) | 33.5 | (5.4) | 32.3 | (2.8) |
| ASTM D638 | | | | | | | | | | | | |
| Flexural modulus, kpsi | 101.8 | (4.5) | 92.6 | (4.1) | 79.6 | (4.4) | 49.6 | (6.7) | 44.1 | (4.7) | 37.9 | (4.2) |
| ASTM 3790 | | | | | | | | | | | | |
| Hardness, Shore D | 65 | | 64 | | 59 | | 57 | | 55 | | 54 | |
| ASTM D2240 | | | | | | | | | | | | |
| Notched Izod, Impact ft-lb/ | 0.89 | (0.11) | 0.88 | (0.31) | .091 | (.17) | 1.29 | (0.07) | 1.65 | (0.15) | 1.91 | (0.38) |
| in@23 ± 1° C. ASTM D256 | | | | | | | | | | | | |

| | | | | | | |
|---|---|---|---|---|---|---|
| Heat Deflection Temperature, | 65 | 69 | 68 | 56 | 50 | 53 |
| ° C.@66 psi ASTM D648 | | | | | | |
| Heat Deflection Temperature, | 51 | 51 | 48 | 48 | 43 | 44 |
| ° C.@264 psi ASTM D638 | | | | | | |

*The values in parentheses are the standard deviation of the measurement.

Finally, it is to be understood that while but only a few embodiments of the present invention have been hereinbefore shown and described, it will be understood that various changes may be made.

For example, whereas a 58 mm extruder is contemplated above, it will be understood that the process is scaleable and, for use, could be used with similar utility in extruders having diameters ranging from 40 mm to at least 92 mm.

Further, whereas the rubber material is indicated as generally falling in the 10 mesh or finer range, it should be understood that size smaller than 40 mesh provides better surface appearance and smaller crumb rubber generally results in better mechanical properties of the resultant compound. Relatively contaminant free crumb rubber in the 60-100 mesh range is routinely available from cryogenic tire recycling and is advantageously used for many purposes of the present invention.

As well, whereas recycled thermoplastic is specifically mentioned, virgin thermoplastic could be used. Moreover, whereas PP, HDPE and LDPE are specifically mentioned in the detailed description and have been tested, it is contemplated that ABS, PET and PVC can also be used with the method. Similarly, whereas cryogenically-ground tire rubber is specifically mentioned and has been tested, it is contemplated rubber ground to similar dimensions by other conventional methodologies could be used.

Further, whereas a compounding temperature of between about 375 F and about 450 F is specified, it will be understood that the compounding temperature depends on the type of thermoplastic; the same applies to residence time in the extruder.

Additionally, whereas a single screw is described above, modifications to the screw are possible. For example, FIG. 2 shows, in schematic form, another embodiment of a screw juxtaposed beside a schematic of a 12 barrel extruder, wherein the extruder barrels are indicated sequentially be reference numerals 1-12, and the screw zones are indicated with reference numerals 22-86. In this arrangement, thermoplastic is introduced in barrel 1, rubber is introduced in barrels 3, 5 and 8, and venting occurs via barrel 11. Table 3, appended hereto, provides details of the screw segments in each zone. Yet another exemplary screw arrangement is described in tabular form in Tables 4A,4B,4 C, 4D. In this arrangement, thermoplastic material is introduced at about elements 202,204, rubber is introduced at about elements 226, 288 and vacuum venting is applied at about elements 288,290. Persons of ordinary skill will readily appreciate the manner of constructing an extruder based on the foregoing, and accordingly, further detail is neither required nor provided.

Yet further, whereas nine and twelve barrel extruders are specifically mentioned, greater or lesser numbers of barrels can be routinely used.

Accordingly, the present invention should be understood as limited only by the accompanying claims, purposively construed.

1. A method for producing thermoplastic elastomer, the method comprising the step of:
blending a mixture including particles of vulcanized rubber material and a molten thermoplastic material such that the rubber material is subjected to mechanical shearing forces and the surfaces of the rubber particles undergo homolytic bond scission to form chains of free radicals which cross-link with the thermoplastic material,
wherein the mixture consists essentially of the rubber and the thermoplastic material and is suitable for subsequent molding.

2. A method according to claim 1, wherein the ratio, by weight, of rubber material to thermoplastic material in the mixture ranges between about 1:9 and about 4:1.

3. A method according to claim 1, wherein the rubber material is cryogenically ground scrap tire rubber.

4. A method according to claim 3, wherein the thermoplastic material is one of PP, HDPE, LDPE, ABS, PET and PVC.

5. A method according to claim 3, wherein the thermoplastic material is one of PP, HDPE and LDPE.

6. A method according to claim 5, wherein the thermoplastic material is molten recycled post-industrial thermoplastic material.

7. A method according to claim 1, wherein the rubber material has a size between 10 mesh and 100 mesh.

8. A method according to claim 1, wherein the rubber material has a size between 10 mesh and 60 mesh.

9. A method according to claim 1, wherein the rubber material has a size between 10 mesh and 40 mesh.

10. A method according to claim 1, wherein blending is carried out in an extruder.

11. A method according to claim 10, wherein the extruder operates at a compounding temperature between about 375 F and about 450 F.

12. A method according to claim 11, wherein the extruder is a twin-screw extruder operating at a screw speed between about 400 rpm and about 650 rpm.

13. A method according to claim 12, wherein the L/D ratio of the extruder is about 36:1.

14. A method according to claim 10, wherein the blending step comprises the following substeps:
feeding a particulate thermoplastic material to the extruder to produce, interiorly of the extruder, the molten thermoplastic material; and
feeding the particles of rubber material into the extruder and to the molten thermoplastic material to produce the mixture.

15. A method according to claim 14, wherein the mixture is subjected to said mechanical shearing forces by passage through kneading blocks.

16. The elastomer produced by the method of claim 1.

17. An article produced by molding the elastomer of claim 16.
